(19) United States
(12) Patent Application Publication
(10) Pub. No.: US 2019/0057480 A1
(43) Pub. Date: Feb. 21, 2019

(54) METHOD AND APPARATUS FOR PROVIDING TRANSPORTATION SERVICE INFORMATION

(71) Applicant: BEIJING DIDI INFINITY TECHNOLOGY AND DEVELOPMENT CO., LTD., Beijing (CN)

(72) Inventors: Niping Zhang, Beijing (CN); Lin Liu, Beijing (CN); Xiaoxue Zhang, Beijing (CN); Ping Yang, Beijing (CN); Lu Li, Beijing (CN)

(73) Assignee: BEIJING DIDI INFINITY TECHNOLOGY AND DEVELOPMENT CO., LTD., Beijing (CN)

(21) Appl. No.: 15/858,697

(22) Filed: Dec. 29, 2017

(30) Foreign Application Priority Data
Aug. 16, 2017 (CN) 201710700638.X

(51) Int. Cl. G06Q 50/30; G06Q 30/02

(52) U.S. Cl. CPC G06Q 50/30; G06Q 30/0206

(57) ABSTRACT

Embodiments of the disclosure relate to methods and apparatuses for providing transportation service information for displaying on a terminal device. The method may include receiving a transportation service request from a terminal device. The method may also include determining a search area for locating a vehicle to provide the requested transportation service. The method may also include determining historical transportation service request data associated with the search area. The method may also include determining demand-supply information associated with the search area based on the historical transportation service request data. The method may further include providing the demand-supply information for displaying on the terminal device.

### TECHNI REFERENCE TO RELATED

The present application is based on and claims the benefits of priority to Chinese Application No. 201710700638.X, filed Aug. 16, 2017, the entire contents of which are incorporated herein by reference.

### TECHNICAL FIELD

The present disclosure relates to information displaying, and more particularly to, methods, apparatus, and computer readable medium for providing information associated with a transportation service on a user terminal.

### BACKGROUND

An online hailing platform (e.g., DiDi™ online) can receive a transportation service request from a passenger and then route the service request to at least one transportation service provider (e.g., a taxi driver, a private car owner, or the like). The service request can be picked up by a service provider, or assigned to a service provider if no one picks up the service request within a predetermined period. In this way, the online hailing platform provides great convenience for both passengers and drivers.

However, when there is an imbalance between the demand and supply of the transportation service in a given geographic region, the turnovers of the transportation service and user experience may be adversely affected. For example, when the number of transportation service requests far exceeds the number of available service vehicles, a passenger needs to pay extra fees to be entitled to receive dynamic dispatching offers to reduce waiting time. Meanwhile, when a passenger has been waiting for a prolonged period of time yet no available service vehicle responds to the transportation service request, the passenger does not know the reasons of delay and how long the wait will be before the request is accepted. Accordingly, the passenger is incapable of adjust travel plan accordingly.

The disclosed methods and apparatus for providing transportation service information address the above problems.

### SUMMARY

Embodiments of the disclosure provide a computer-implemented method for generating transportation service information for displaying on a terminal device. The method may include receiving a first transportation service request from the terminal device. The method may also include determining a search area for locating a vehicle to provide the requested transportation service. The method may also include determining historical transportation service request data associated with the search area. The method may also include determining demand-supply information associated with the search area based on the historical transportation service request data. The method may further include providing the demand-supply information for displaying on the terminal device.

Embodiments of the disclosure further disclose a device for providing transportation service. The device may include a communication interface in communication with a terminal device. The device may also include a memory storing instructions. The device may further include a processor coupled to the communication interface and the memory. The processor is configured to execute the instructions to receive a transportation service request from the terminal device. The processor is further configured to determine a search area for locating a vehicle to provide the requested transportation service and determine historical transportation service request data associated with the search area. The processor is also configured to determine demand-supply information associated with the search area based on the historical transportation service request data and provide the demand-supply information for displaying on the terminal device.

Embodiments of the disclosure further disclose a non-transitory computer-readable medium that stores a set of instructions, when executed by at least one processor of a server, cause a terminal device to perform a method for providing information relating to a transportation service. The method may include receiving a transportation service request from the terminal device. The method may also include determining a search area for locating a vehicle to provide the requested transportation service. The method may also include determining historical transportation service request data associated with the search area. The method may also include determining demand-supply information associated with the search area based on the historical transportation service request data. The method may further include providing the demand-supply information for displaying on the terminal device.

It is to be understood that both the foregoing general description and the following detailed description are exemplary and explanatory only and are not restrictive of the embodiments as disclosed.

### BRIEF DESCRIPTION OF THE DRAWINGS

FIG. 1 is a schematic diagram of an exemplary system for providing information relating to a transportation service, according to embodiments of the present disclosure.

FIG. 2 is a schematic diagram illustrating an exemplary passenger terminal used by the system of FIG. 1, according to embodiments of the present disclosure.

FIG. 3 is a flowchart of an exemplary method for providing transportation service information, according to embodiments of the present disclosure.

FIG. 4 is a schematic diagram illustrating an exemplary passenger terminal used by the system of FIG. 1, according to embodiments of the present disclosure.

FIG. 5 is a schematic diagram illustrating an exemplary user interface used by the passenger terminal of FIG. 4 for displaying transportation service information, according to embodiments of the present disclosure.

FIG. 6 is a schematic diagram illustrating an exemplary user interface used by the passenger terminal of FIG. 4 for displaying transportation service information, according to embodiments of the present disclosure.

FIG. 7 is a schematic diagram illustrating an exemplary user interface used by the passenger terminal of FIG. 4 for displaying transportation service information, according to embodiments of the present disclosure.

FIG. 8 is a schematic diagram illustrating an exemplary user interface used by the passenger terminal of FIG. 4 for displaying transportation service information, according to embodiments of the present disclosure.

FIG. 9 is a schematic diagram illustrating an exemplary user interface used by the passenger terminal of FIG. 4 for displaying transportation service information, according to embodiments of the present disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

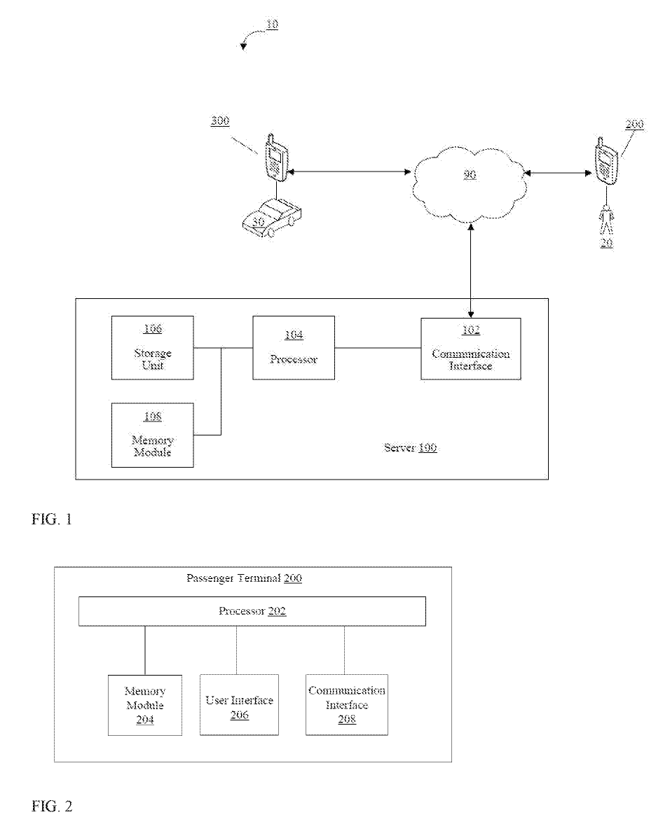

FIG. 1 is a schematic diagram of an exemplary system 10 for providing information relating to a transportation service, according to embodiments of the present disclosure.

Referring to FIG. 1, system 10 may include a server 100 for providing information relating to a transportation service. Server 100 may be a general-purpose server or a proprietary device specially designed for managing transportation service requests. It is contemplated that, server 100 can be a separate system or an integrated component of a larger computing system. In some embodiments, server 100 may include sub-systems, some of which may be remote.

Consistent with the disclosed embodiments, server 100 may include, among other things, a communication interface 102, a processor 104, a storage unit 106, and a memory module 108. At least some of these components of server 100 may be configured to transfer data and send or receive instructions between or among each other.

Communication interface 102 may be configured to communicate with one or more passengers 20 and service vehicles 30. Specifically, each passenger 20 may have an associated passenger terminal 400 used for communicating with server 100. For example, passenger terminal 400 may be a smart phone, a tablet, a wearable device, a computer, or the like. Passenger 20 may use passenger terminal 400 to send a transportation service request to server 100. The transportation service request may include a current location of passenger 20, an origin and a destination of the requested transportation service, a request time, or the like. Generally, the origin of the requested transportation service can overlap with a location of passenger 20 and/or passenger terminal 400. However, it is contemplated that the origin of the requested transportation can also differ from the location of passenger terminal 400, even if the transportation service request is sent from passenger terminal 400. For example, a user can request a transportation service from a computer for her friend, who is distant from this user.

Similarly, each service vehicle 30 may have an associated communication device 300 used for communicating with server 100. Consistent with the disclosed embodiments, communicating device 300 may be integrated in vehicle 30, or may be a mobile terminal, e.g., a smart phone, a tablet computer, a wearable device, etc., carried by the driver of vehicle 30. Communication interface 102 may receive vehicle information of service vehicle 20 from communication device 22. Service vehicle 20 may be a taxi car or a private car. It is contemplated that service vehicle 20 can also be an autonomous vehicle. The vehicle information may include at least one of location, capacity, current driving direction, vehicle model, or other features of service vehicle 20.

In various disclosed embodiments, communication interface 102 may be an integrated services digital network (ISDN) card, cable modem, satellite modem, or a modem to provide a data communication connection between server 100 and other devices, such as passenger terminal 400 and communication device 300. As another example, communication interface 102 may be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network 90. Network 90 may typically include a cellular communication network, a Wireless Local Area Network (WLAN), a Wide Area Network (WAN), or the like.

Processor 104 may be one or more known processing devices, such as a microprocessor from the Pentium™ family manufactured by Intel™ or the Turion™ family manufactured by AMD™. Processor 104 may constitute a single core or multiple core processors that executes parallel processes simultaneously. For example, processor 104 may be a single core processor configured with virtual processing technologies. In certain embodiments, processor 104 may use logical processors to simultaneously execute and control multiple processes. Processor 104 may implement virtual machine technologies, or other known technologies to provide the ability to execute, control, run, manipulate, store, etc. multiple software processes, applications, programs, etc. In another embodiment, processor 104 may include a multiple-core processor arrangement (e.g., dual, quad core, etc.) configured to provide parallel processing functionalities to allow server 100 to execute multiple processes simultaneously. One of ordinary skill in the art would understand that other types of processor arrangements could be implemented that provide for the capabilities disclosed herein.

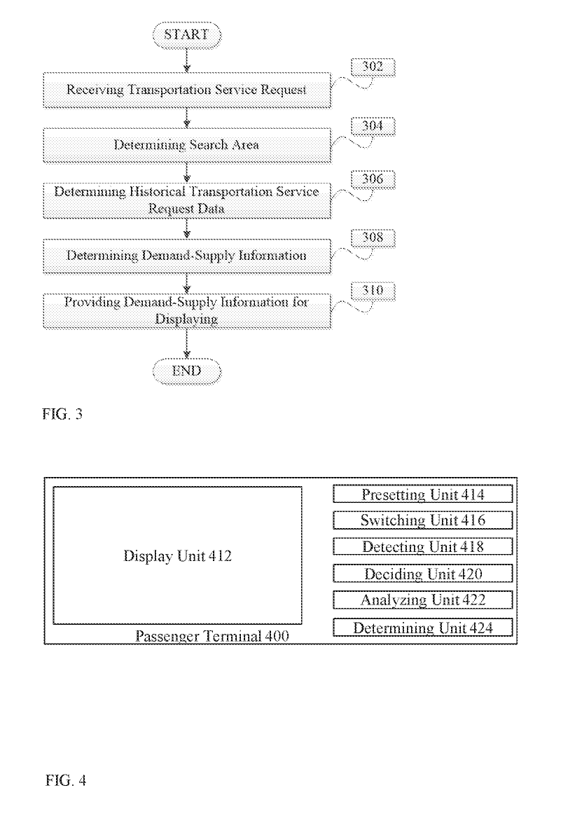

Processor 104 may execute computer instructions (program codes) stored in storage unit 106 and memory module 108, and may perform functions in accordance with exemplary techniques described in this disclosure. More exemplary functions of processor 104 will be described later in relation to FIG. 3.

Storage unit 106 and memory module 108 may include any appropriate type of mass storage provided to store any type of information that processor 104 may need to operate. Storage unit 106 and memory module 108 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Storage unit 106 and/or memory module 108 may be configured to store one or more computer programs that may be executed by processor 104 to perform exemplary functions for providing transportation service information, as disclosed in this application. Storage unit 106 and/or memory module 108 may be further configured to store information and data used by processor 104.

FIG. 2 is a schematic diagram illustrating an exemplary passenger terminal 400, according to embodiments of the present disclosure. As shown in FIG. 2, passenger terminal 400 may include a processor 202, a memory module 204, a user interface 206, and a communication interface 208.

In exemplary embodiments, processor 202 may include any appropriate type of general purpose or special-purpose microprocessor, digital signal processor, or microprocessor. Processor 202 may be configured as a separate processor module dedicated to performing the disclosed methods for providing information relating to a transportation service. Alternatively, processor 202 may be configured as a shared processor module for performing other functions of passenger terminal 400 unrelated to the disclosed methods for providing information relating to a transportation service. In the exemplary embodiments, processor 202 may execute computer instructions (program codes) stored in memory module 204, and may perform functions in accordance with exemplary techniques described in this disclosure.

Memory module 204 may include any appropriate type of mass storage provided to store any type of information that processor 202 may need to operate. Memory module 204 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory module 204 may be configured to store one or more computer programs that may be executed by processor 202 to perform the disclosed methods for providing information relating to a transportation service.

User interface 206 may include a display panel. The display panel may include a liquid crystal display (LCD), a light-emitting diode (LED), a plasma display, a projection, or any other type of display, and may also include microphones, speakers, and/or audio input/outputs (e.g., headphone jacks).

User interface 206 may also be configured to receive input or commands from passenger 20. For example, the display panel may be implemented as a touch screen to receive input signals from the user. The touch screen includes one or more touch sensors to sense touches, swipes, and other gestures on the touch screen. The touch sensors may not only sense a boundary of a touch or swipe action, but also sense a period of time and a pressure associated with the touch or swipe action. Alternatively or in addition, user interface 206 may include other input devices such as keyboards, buttons, joysticks, and/or tracker balls. User interface 206 may be configured to send the user input to processor 202.

Communication interface 208 can access a wireless network, e.g., network 90, based on one or more communication standards, such as WiFi, LTE, 2G, 3G, 4G, 5G, etc. Communication interface 208 may have a configuration similar to communication interface 102. As described in more detail below, communication interface 208 may be configured to send a transportation service request to server 100 and receive transportation service information from server 100.

The structures of communication device 300 are similar to those of passenger terminal 400, which will not be repeated herein. It is to be understood that the configuration and boundaries of the functional building blocks of system 10 (FIG. 1) have been defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 3 is a flowchart of an exemplary method 300 for providing information relating to a transportation service, according to embodiments of the disclosure. For example, method 300 may be performed by server 100. Referring to FIG. 3, method 300 may include the following steps.

In step 302, server 100 may receive a transportation service request from passenger terminal 400. The first transportation service request may be transmitted from passenger terminal 400 to server 100 via network 90. The first transportation service request may include information indicating a current location of passenger 20, an origin and a destination of the requested transportation service, a request time, or the like.

In step 304, server 100 may determine a search area for locating a service vehicle 30 to provide the requested transportation service. For example, the search area may be determined based on the current location of passenger 20 and/or the origin of the requested transportation service. In particular, server 100 may set the search area as an area include or close to the origin of the trip as specified by the transportation service request. In some embodiments, server 100 may divide a given geographic region (e.g., a metropolitan area) into a plurality of sub-regions. Server 100 may select a sub-region encompassing the origin of the requested transportation service as the search area.

Consistent with the disclosed embodiments, after receiving the transportation service request, server 100 may broadcast the transportation service request to service vehicles 20 (or communication devices 300) located in the search area. As such, the search area is also referred to as a “broadcasting zone” of the transportation service request. If a service vehicle 20 in the search area is currently available for picking up passenger 20, the driver of the service vehicle 20 may operate the associated communication device 300 to accept the transportation service request and proceed to pick up passenger 30. If currently there is no available service vehicles 20, server 100 may place the transportation service request in a queue, and assign it to the next available service vehicle 20.

In step 306, server 100 may determine historical transportation service request data associated with the search area. The historical transportation service request data includes records of transportation service requests received by the disclosed online hailing platform within a predetermined period of time before the transportation service request is generated. In the disclosed embodiments, server 100 may periodically collect the historical transportation service request data and save it in storage unit 106 and/or memory module 108. Alternatively or additionally, server 100 may retrieve the historical transportation service request data from a remote data center or a cloud storage.

The historical transportation service request data may be organized with different operating zones. An operating zone is a geographic region in which the origin points of the associated transportation service requests are located. Server 100 may preset a corresponding relation between search areas of transportation service requests and operating zones of the historical transportation service request data. In some embodiments, the operating zone of a transportation service request is the same as the broadcasting zone of the transportation service request. Consistent with the disclosed embodiments, server 100 may obtain the historical transportation service request data whose operating zone corresponding to the search area (i.e., broadcasting zone) of the transportation service request.

In step 308, server 100 may determine demand-supply information associated with the search area based on the historical transportation service request data. Specifically, the historical transportation service request data may include the amount of demand for the transportation service (e.g., the amount of transportation service requests) and the amount of supply of the transportation service (e.g., the number of service vehicles 20 available for providing the transportation service) in the search area. To determine the demand-supply information, server 100 may determine a difference value by subtracting the amount of supply of the transportation service from the amount of the demand for the transportation service.

In step 310, server 100 may provide the demand-supply information for displaying on passenger terminal 400. Specifically, based on the difference value, server 100 may generate various instructions for passenger terminal 400 to display the related demand-supply information.

When the difference value is larger than a first threshold value, server 100 may transmit a first instruction to passenger terminal 100. The first instruction causes passenger terminal 100 to display, via user interface 206, a diagram indicating the amount of transportation service requests and the amount of supply of the transportation service. The diagram may include at least one of a histogram, a line chart, a pie, a bar chart, a donut chart, a bubble chart, or a radar chart.

When the difference is larger than a second threshold value, server 100 may transmit a second instruction to passenger terminal 100. The second instruction causes passenger terminal 100 to: activate a transportation service scheduling interface; detect, at a first preset time interval, whether an update of the historical transportation service request data is received; and in response to the update of the historical transportation service request data being received, refresh the diagram.

Server 100 may also generate at least one of an amount of extra fee or a multiplying factor of regular service fee for dispatching transportation capacity outside the broadcasting zone to fulfill the transportation service request. Server 100 may then transmit a third instruction to passenger terminal 400. The third instruction causes passenger terminal 400 to: display the at least one of the amount of extra fee or the multiplying factor of regular service fee; detect, at a second preset time interval, whether an update of the at least one of the amount of extra fee or the multiplying factor of regular service fare is received; and in response to the update of the at least one of the amount of extra fee or the multiplying factor of regular service fare being received, refresh the displayed at least one of the amount of extra fee or the multiplying factor of regular service fee.

Corresponding method 300 performed by server 100, the present disclosure also provides structures and methods used by passenger terminal 400 for displaying the transportation service information. FIG. 4 is a schematic diagram illustrating a passenger terminal 400, according to embodiments of the present disclosure. Referring to FIG. 4, passenger terminal 400 includes a displaying unit 412, a presetting unit 414, a switching unit 416, a detecting unit 418, a deciding unit 420, an analyzing unit 422, and a determining unit 424. Passenger terminal 400 is configured to receive and display demand-supply information associated with a transportation request.

In these embodiments, receiving demand-supply information corresponding to historical transportation service request record and displaying thereof can enable users to understand the demand-supply condition of operation of online hailing, especially when the amount of transportation service requests is larger than the amount of available operation resources. At one side, through the demand-supply information, users can understand the reason of a dynamic adjusting plan occurs and how a dynamic adjusting charge occurs. At the other side, users are enabled to adjust trip plan in accordance with the demand-supply information. For example, if the transportation service request is an exclusive booking of express car service, users can collaterally send a sharing request of express car service, or a request of different car model (e.g., taxi, special car, limousine, hitch-hike, etc.), so that users' transportation needs are fulfilled to the maximum extent and user experience is improved.

The transportation service request includes trip information of an origin, a destination, and set-out time, etc. A background process sends the trip information to a server. The server generates demand-supply information in accordance with the historical transportation service request records of the operation zone where the origin belongs to. The demand-supply information is sent to a terminal device, e.g., passenger terminal 400. The terminal device displays the demand-supply information on a user interaction interface and reminds users intuitively.

Presetting unit 414 is configured to preset a corresponding relationship between a broadcasting zone of the booking and an operating zone of the historical booking record. The historical booking record is a record of bookings within a preset period of time before the booking has been generated. The historical booking record includes the total amount of bookings generated and the amount of available transportation resource. The broadcasting zone of a booking is the operating zone where the trip origin belongs to. Through the corresponding relationship between the broadcasting zone of the booking and the operating zone of historical booking records, the total amount of bookings and the amount of available transportation resource can best reflect the demand-supply condition immediately before the booking is sent, so that the accuracy and reliability of the demand-supply information is improved.

Therefore, displaying unit 412 is further configured to generate and display a diagram corresponding to the total amount of transportation service requests generated and the amount of available transportation resource, when a transportation service request is detected to be sent, and when the differential value between the total amount of transportation service requests generated and the amount of available transportation resource is larger than a first preset differential value. The diagram is at least one of a histogram, a line chart, a pie chart, a bar chart, a donut chart, a bubble chart, or a radar chart.

When the differential value between the total amount of transportation service requests generated and the amount of available transportation resource is larger than a first preset differential value, a severe demand-supply unbalance occurs. It is highly likely that the transportation service request waiting to be sent cannot be responded in time. In such scenario, by generating and displaying the diagram corresponding to the total amount of transportation service requests generated and the amount of available transportation resource, the memory consumption of passenger terminal 400 is effectively reduced and the energy efficiency of end device is improved. Users can intuitively understand demand-supply condition and adjust trip plan according to the diagram.

Switching unit 416 is configured to switch to transportation resource scheduling interface when the differential value between the total amount of transportation service requests generated and the amount of available transportation resource is larger than a second preset differential value. Detecting unit 418 is configured to detect if the diagram is updated according to a first preset cycle. When the diagram is detected to be updated, a diagram is refreshed and displayed. When the diagram is not detected to be updated, a diagram is not refreshed and displayed.

In these embodiments, by switching to transportation resource scheduling interface when the differential value between the total amount of transportation service requests generated and the amount of available transportation resource is larger than a second preset differential value, a user is prompted whether he or she wants to raise a charge to schedule an available transportation resource out of the operation zone which the origin of his or her trip belongs to. Accordingly, users' transportation needs are fulfilled to the maximum extent and user experience is improved. Meanwhile, turnover volume of Internet car booking is elevated. Further, when the diagram is not detected to be updated, a diagram is not refreshed and displayed, so that energy efficiency of passenger terminal 400 is improved effectively.

Deciding unit 420 is configured to deciding a dynamic adjusting charge, or a multiplying factor of regular service fare, or a combination thereof, to dynamically schedule available transportation resource out of the broadcasting zone. Detecting unit 418 is further configured to detect if the dynamic adjusting charge or the multiplying factor of regular service fare, or the combination thereof is adjusted in accordance with a second preset cycle. Displaying unit 412 is further configured to refresh and display the dynamic adjusting charge, or the multiplying factor of regular service fare, or the combination thereof, when the dynamic adjusting charge, the multiplying factor of regular service fare, or the combination thereof is detected to be adjusted. Displaying unit 412 is further configured to not refresh and display the dynamic adjusting charge, or the multiplying factor of regular service fare, or the combination thereof, in response to the dynamic adjusting charge, or the multiplying factor of regular service fare, or the combination thereof is not detected to be adjusted.

In these embodiments, by deciding a dynamic adjusting charge, or a multiplying factor of regular service fare, or a combination thereof, to dynamically schedule available transportation resource out of the broadcasting zone, and refreshing and displaying the dynamic adjusting charge, or the multiplying factor of regular service fare, or the combination thereof when the dynamic adjusting charge, or the multiplying factor of regular service fare, or the combination thereof is detected to be adjusted, users can intuitively understand it is the demand-supply imbalance leading to the scheduling of transportation resources. It is more comprehensible to users to accept the plan of transportation resources scheduling. Users' transportation needs are fulfilled and meanwhile turnover volume of Internet car booking is elevated.

Analyzing unit 422 is configured to analyze characteristic information of a transportation service request, when the transportation service request is detected to be sent. Determining unit 424 is configured to determine whether the characteristic information is matching with preset characteristic information or not. Displaying unit 412 is further configured to generate scene prompting information corresponding to the matched preset characteristic information, when the characteristic information is determined to be matched with one piece of the preset characteristic information. The preset characteristic information includes at least one of weather characteristic information, time characteristic information, area characteristic information, and road condition characteristic information.

In these embodiments, by analyzing characteristic information of the transportation service request, and generating scene prompting information corresponding to the matched preset characteristic information, when the characteristic information is determined to be matched with one piece of the preset characteristic information, users can intuitively understand the cause of demand-supply imbalance, for example, rainy or hazy weather (weather characteristic information), morning rush and evening rush (time characteristic information), commercial area with large stream of people, school zone, remote area, and residential area (zone characteristic information), accident or congestion around trip origin (road condition characteristic information).

Next, FIGS. 5-9 are provided to illustrate the display interfaces used by passenger terminal 400 for displaying the transportation service information.

FIG. 5 is a schematic diagram illustrating an exemplary user interface used by passenger terminal 400 for displaying transportation service information, according to embodiments of the present disclosure. With reference to FIG. 5, the exemplary interface for an information displaying plan comprises demand-supply prompting information 402, dynamic scheduling prompting information 404, characteristic information of a transportation service request 406, controlling interface of raising 408, and controlling interface of waiting 410. Demand-supply prompting information corresponding to historical transportation service request record received and displayed by passenger terminal 400, when a transportation service request is detected to be sent. Demand-supply prompting information 402 can be configured to be “about 8 available cars” as the amount of available transportation resource and “about 15 persons are booking” as the total amount of transportation service requests generated. Dynamic scheduling prompting information 404 is configured to display a dynamic adjusting charge, or a multiplying factor of regular service fare, or a combination thereof of a dynamical schedule of an available transportation resource out of the broadcasting zone. For example, dynamic scheduling prompting information 404 can be configured to “increase by 0.5 time” and “increase to 39.5 or so, increased part goes to driver”. Dynamic scheduling prompting information 404 is refreshed and updated according to a cycle or an update of data. Characteristic information of a transportation service request 406 is configured to display the cause of dynamic scheduling. Characteristic information of a transportation service request 406 is configured to display the characteristic information of a transportation service request, for example, “too many users' transportation service requests due to rainy and snowy weather”. Controlling interface of raising 408 and controlling interface of waiting 410 are configured to allow users to choose how they prefer to proceed, for example, “agree to pay more to driver” as controlling interface of raising 408 and “request again in a while” as controlling interface of waiting 410.

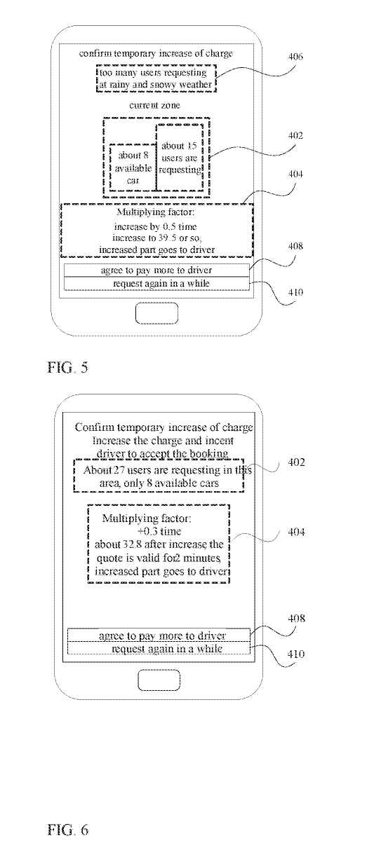

FIG. 6 is a schematic diagram illustrating an exemplary user interface used by the passenger terminal 400 for displaying transportation service information, according to embodiments of the present disclosure. With reference to FIG. 6, the user interface for information displaying comprises simplified demand-supply prompting information 402 and adjusted dynamic scheduling prompting information 404. The user interface is configured to switch to transportation resource scheduling interface when the differential value between the total amount of transportation service requests generated and the amount of available transportation resource is larger than a second preset differential value. Simplified demand-supply prompting information 402 can be configured to text information, for example, “about 27 users are booking, only 8 available cars.” Adjusted dynamic scheduling prompting information 404 can be configured to “increase by 0.3 time, increase to 32.8 or so, the quotation is good for 2 minutes, and increased part goes to driver.” The configuration is for the purpose of encouraging uptakes of dynamic scheduling plans by users.

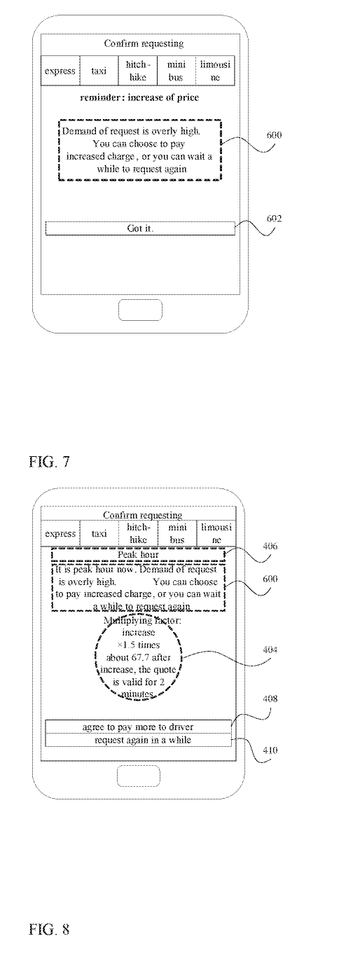

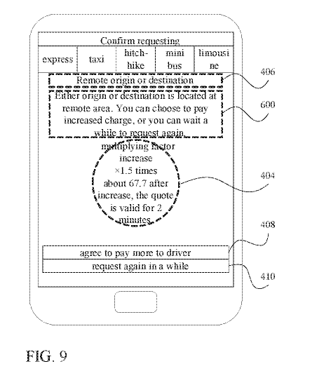

FIG. 7 is a schematic diagram illustrating an exemplary user interface used by the passenger terminal 400 for displaying transportation service information, according to embodiments of the present disclosure. With reference to FIG. 7, the user interface of passenger terminal 400 displays dynamic prompting information 600 and a user confirmation triggering port 602. Dynamic prompting information 600 can be “The demand in the area is high, you can choose to increase fees to expedite your trip, or you can try to book again in a while.” A user confirmation triggering port 602 can show message like “Get it.” When user confirmation triggering port 602 is triggered by users, interface switches to transportation resource scheduling pages as shown in FIG. 8 or 9.

Interface for transportation resource scheduling, e.g. as shown in FIGS. 8 and 9, includes characteristic information of a transportation service request 406. In FIG. 8, characteristic information of a transportation service request 406 says “peak hours,” and in FIG. 9, characteristic information of a transportation service request 406 says “remote origin or destination,” so that users are intuitively directed and enabled to understand the cause of dynamic adjusting. The transparency of operating cost and user experience are improved. It is made more convenient for users to timely adjust trip plan.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for generating transportation service information for displaying on a terminal device, comprising:
receiving a transportation service request from the terminal device;
determining a search area for locating a vehicle to provide the requested transportation service;
determining historical transportation service request data associated with the search area;
determining demand-supply information associated with the search area based on the historical transportation service request data; and
providing the demand-supply information for displaying on the terminal device.

2. The method of claim 1, wherein the historical transportation service request data includes an amount of transportation service requests and an amount of supply of the transportation service within a preset period of time before the transportation service request is received.

3. The method of claim 2, wherein determining historical transportation service request data associated with the search area comprises:
determining the historical transportation service request data based on a predetermined relationship between the search area of the transportation service request and an operating zone of the historical transportation service request data.

4. The method of claim 2, further comprising:
determining a difference between the amount of transportation service requests and the amount of supply of the transportation service within the preset period of time before the transportation service request is received;
when the difference is larger than a first threshold value, transmitting a first instruction to the terminal device, the first instruction causing the terminal device to display a diagram indicating the amount of transportation service requests and the amount of supply of the transportation service.

5. The method of claim 4, wherein the diagram including at least one of a histogram, a line chart, a pie, a bar chart, a donut chart, a bubble chart, or a radar chart.

6. The method of claim 4, further comprising:
when the difference is larger than a second threshold value, transmitting a second instruction to the terminal device, the second instruction causing the terminal device to:
refresh the diagram in response to an update of the historical transportation service request data being received.

7. The method of claim 6, further comprising:
generating at least one of an amount of extra fee or a multiplying factor of regular service fare for dispatching transportation capacity outside the search area to fulfill the transportation service request; and
transmitting a third instruction to the terminal device, the third instruction causing the terminal device to:
display the at least one of the amount of extra fee or the multiplying factor of regular service fare; and
refresh the displayed at least one of the amount of extra fee or the multiplying factor of regular service fare in response to an update of the at least one of the amount of extra fee or the multiplying factor of regular service fare being received.

8. A device for providing transportation service, comprising:
a communication interface in communication with a terminal device;
a memory storing instructions; and
a processor coupled to the communication interface and the memory, the processor configured to execute the instructions to:
receive a transportation service request from the terminal device;
determine a search area for locating a vehicle to provide the requested transportation service;
determine historical transportation service request data associated with the search area;
determine demand-supply information associated with the search area based on the historical transportation service request data; and
provide the demand-supply information for displaying on the terminal device.

9. The device of claim 8, wherein the processor is further configured to:
preset a corresponding relationship between the search area of the transportation service request and an operating zone of the historical transportation service request data;
wherein the historical transportation service request data includes an amount of transportation service requests and an amount of supply of the transportation service within a preset period of time before the transportation service request is received.

10. The device of claim 9, wherein the processor is further configured to:
determine the historical transportation service request data based on a predetermined relationship between the search area of the transportation service request and an operating zone of the historical transportation service request data.

11. The device of claim 9, wherein the processor is further configured to:
determine a difference between the amount of transportation service requests and the amount of supply of the transportation service within the preset period of time before the transportation service request is received;
when the difference is larger than a first threshold value, transmit a first instruction to the terminal device, the first instruction causing the terminal device to:
display a diagram indicating the amount of transportation service requests and the amount of supply of the transportation service, the diagram including at least one of a histogram, a line chart, a pie, a bar chart, a donut chart, a bubble chart, or a radar chart.

12. The device of claim 11, wherein the processor is further configured to:
when the difference is larger than a second threshold value, transmit a second instruction to the terminal device, the second instruction causing the terminal device to:
activate a transportation service scheduling interface;
detect, at a first preset time interval, whether an update of the historical transportation service request data is received; and
refresh the diagram in response to an update of the historical transportation service request data being received, refresh the diagram.

13. The device of claim 12, wherein the processor is further configured to:
generate at least one of an amount of extra fee or a multiplying factor of regular service fare for dispatching transportation capacity outside the broadcasting zone to fulfill the transportation service request; and
transmit a third instruction to the terminal device, the third instruction causing the terminal device to:
display the at least one of the amount of extra fee or the multiplying factor of regular service fare; and
refresh the displayed at least one of the amount of extra fee or the multiplying factor of regular service fare in response to an update of the at least one of the amount of extra fee or the multiplying factor of regular service fare being received, refresh the displayed at least one of the amount of extra fee or the multiplying factor of regular service fare.

14. A non-transitory computer-readable medium that stores a set of instructions, when executed by at least one processor of a server, cause a terminal device to perform a method comprising:
receiving a transportation service request from the terminal device;
determining a search area for locating a vehicle to provide the requested transportation service;
determining historical transportation service request data associated with the search area;
determining demand-supply information associated with the search area based on the historical transportation service request data; and
providing the demand-supply information for displaying on the terminal device.

15. The non-transitory computer-readable medium of claim 14, wherein:
the search area of the transportation service request corresponds to an operating zone of the historical transportation service request data; and
the historical transportation service request data includes an amount of transportation service requests and an amount of supply of the transportation service within a preset period of time before the transportation service request is received.

16. The non-transitory computer-readable medium of claim 15, wherein the method further comprises:
sending a first instruction to the terminal device, the first instruction indicating that a difference between the amount of transportation service requests and the amount of supply of the transportation service is larger than a first threshold value; and
in response to receiving the first instruction, displaying, on the user interface of the terminal device, a diagram indicating the amount of transportation service requests and the amount of supply of the transportation service, the diagram including at least one of a histogram, a line chart, a pie, a bar chart, a donut chart, a bubble chart, or a radar chart.

17. The non-transitory computer-readable medium of claim 16, wherein the method further comprises:
sending a second instruction to the terminal device, the second instruction indicating that the difference between the amount of transportation service requests and the amount of supply of the transportation service is larger than a second threshold value; and
in response to receiving the second instruction:
activating a transportation service scheduling interface;
detecting, at a first preset time interval, whether an update of the historical transportation service request data is received; and
in response to the update of the historical transportation service request data being received, refreshing the diagram.

18. The non-transitory computer-readable medium of claim 17, wherein the method further comprises:
generating at least one of an amount of extra fee or a multiplying factor of regular service fare for dispatching transportation capacity outside the search area to fulfill the transportation service request, and
sending a third instruction to the terminal device; and
in response to the third instruction:
displaying at least one of an amount of extra fee or a multiplying factor of regular service fee for dispatching transportation capacity outside the search area to fulfill the transportation service request;
detecting, at a second preset time interval, whether an update of the at least one of the amount of extra fee or the multiplying factor of regular service fare is received from the server; and
in response to the update of the at least one of the amount of extra fee or the multiplying factor of regular service fare being received, refreshing the displayed at least one of the amount of extra fee or the multiplying factor of regular service fee.

19. The non-transitory computer-readable medium of claim 14, wherein the method further comprises:
analyzing characteristic information of the transportation service request;
determining whether the characteristic information matches one or more of preset attributes, the preset attributes including at least one of weather, time, area, or road condition;
in response to the characteristic information being determined to match one or more of the preset attributes, generating scene prompting information representative of the matched preset attributes.
